(19) United States
(12) Patent Application Publication
(10) Pub. No.: US 2014/0025866 A1
(43) Pub. Date: Jan. 23, 2014

(54) NONVOLATILE MEMORY DEVICE AND OPERATING METHOD

(71) Applicant: SAMSUNG ELECTRONICS CO., LTD., SUWON-SI (KR)

(72) Inventors: BOH-CHANG KIM, YONGIN-SI (KR); DONGKYO SHIM, SEOUL (KR); KITAE PARK, SEONGNAM-SI (KR)

(21) Appl. No.: 13/915,676

(22) Filed: Jun. 12, 2013

(30) Foreign Application Priority Data
Jul. 23, 2012 (KR) 10-2012-0080184

(51) Int. Cl. G06F 12/02

(52) U.S. Cl. CPC G06F 12/0246
USPC 711/103

(57) ABSTRACT

A method of programming data in a nonvolatile memory via a first memory cell group and a second memory cell group in a page of memory cells includes; executing a first program operation that programs the first memory cell group with a first program voltage that is stepwise adjusted by a first increment over successive programming loop iterations, and thereafter executing a second program operation that programs the second memory cell with a second program voltage that is stepwise adjusted by a second increment over successive programming loop iterations, wherein the first program voltage is different from the second program voltage.

### CROSS-REFERENCE TO RELATED APPLICATIONS

A claim for priority under 35 U.S.C. §119 is made to Korean Patent Application No. 10-2012-0080184 filed Jul. 23, 2012, in the Korean Intellectual Property Office, the entire contents of which are hereby incorporated by reference.

### BACKGROUND

The inventive concept relates to nonvolatile memory devices and methods of programming data and reading data.

Volatile memory devices lose stored data in the absence of applied power, and include static RAM (SRAM), dynamic RAM (DRAM), synchronous DRAM (SDRAM), and the like. Nonvolatile memory devices are able to retain stored data even in the absence of applied power, and include read only memory (ROM), a programmable ROM (PROM), an electrically programmable ROM (EPROM), an electrically erasable and programmable ROM (EEPROM), a flash memory device, a phase-change RAM (PRAM), a magnetic RAM (MRAM), a resistive RAM (RRAM), a ferroelectric RAM (FRAM), and the like. The flash memory device is roughly divided into a NOR type and a NAND type.

NAND flash memory devices typically perform program and read operations on a page basis. As page size has increased and programming/reading operations have become more complex, it has become increasingly difficult to avoid disturbing threshold voltage distributions of previously programmed memory cells due to various coupling effects.

### SUMMARY

In one embodiment, the inventive concept provides a method of programming data in a nonvolatile memory device having a memory cell array that arranges a first memory cell group and a second memory cell group in a page of memory cells commonly coupled to a selected word line, the method comprising; executing a first program operation comprising; programming the first memory cell group by applying a first program voltage to the selected word line, wherein the first program voltage is stepwise adjusted by a first increment over successive programming loop iterations, and thereafter, executing a second program operation; comprising; programming the second memory cell group by applying a second program voltage to the selected word line, wherein the second program voltage is stepwise adjusted by a second increment over successive programming loop iterations, wherein the first program voltage is different from the second program voltage.

In another embodiment, the inventive concept provides a method of reading data in a nonvolatile memory device having a memory cell array that arranges a first memory cell group and a second memory cell group in a page of memory cells commonly coupled to a selected word line, the method comprising; reading the first memory cell group by applying a first read voltage to the selected word line, and thereafter, reading the second memory cell group by applying a second read voltage to the selected word line, wherein the first read voltage is different from the second read voltage.

In one embodiment, the inventive concept provides a nonvolatile memory device, comprising; a memory cell array arranging a first memory cell groups and a second memory cell group along a selected word line, and control logic configured to provide the selected word line with a first program voltage during a first program operation directed to the first memory cell group, wherein the first program voltage is stepwise adjusted by a first increment over successive programming loop iterations of the first program operation, and thereafter, with a second program voltage during a second program operation directed to the second memory cell group, wherein the second program voltage is stepwise adjusted by a second increment over successive programming loop iterations, and the first program voltage is different from the second program voltage.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a nonvolatile memory device according to an embodiment of the inventive concept.

FIG. 2 is a diagram illustrating a unit page of a memory cell array in FIG. 1.

FIG. 3 is a diagram illustrating memory cells forming a unit page in FIG. 2.

FIGS. 4A and 4B are diagrams illustrating a coupling phenomenon when selected memory cells of a memory cell array in FIG. 3 are programmed.

FIGS. 5A and 5B are diagrams illustrating a program operation of a nonvolatile memory device according to an embodiment of the inventive concept.

FIGS. 6A and 6B are diagrams concretely illustrating a program operation of a nonvolatile memory device according to an embodiment of the inventive concept.

FIGS. 7 and 8 are diagrams illustrating a read operation of a nonvolatile memory device according to an embodiment of the inventive concept.

FIG. 9 is a flow chart illustrating an operating method of a nonvolatile memory device according to an embodiment of the inventive concept.

FIG. 10 is a flow chart illustrating a read method of a nonvolatile memory device according to an embodiment of the inventive concept.

FIG. 11 is a block diagram schematically illustrating a memory system according to an embodiment of the inventive concept.

FIG. 12 is a block diagram illustrating an application of a memory system in FIG. 11.

FIG. 13 is a block diagram schematically illustrating a computing system including a memory system in FIG. 12.

### DETAILED DESCRIPTION

Embodiments of the inventive concept will now be described in some additional detail with reference to the accompanying drawings. The inventive concept may, however, be embodied in various different forms, and should not be construed as being limited to only the illustrated embodiments. Rather, the illustrated embodiments are provided as examples so that this disclosure will be thorough and complete, and will fully convey the inventive concept to those skilled in the art. Accordingly, known processes, elements, and techniques are not described with respect to certain embodiments of the inventive concept. Unless otherwise noted, like reference numbers and label denote like or similar elements throughout the attached drawings and written description.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

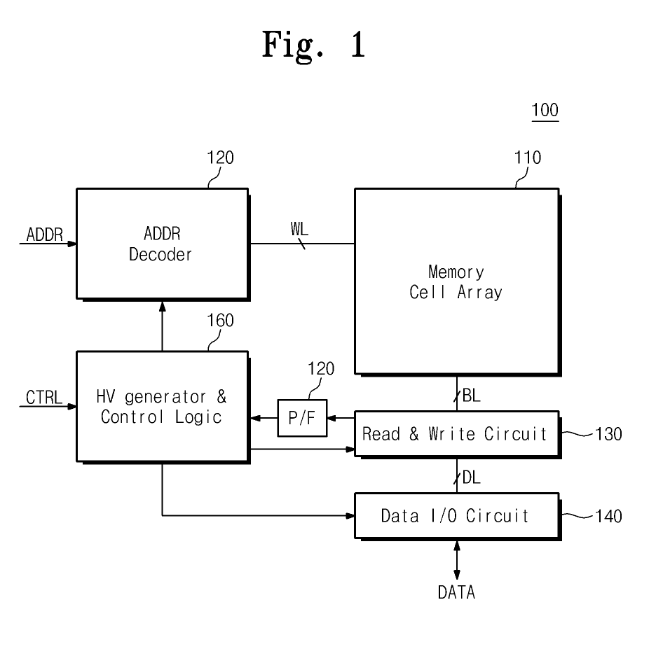

FIG. 1 is a block diagram illustrating a nonvolatile memory (NVM) device 100 according to an embodiment of the inventive concept. Hereafter, the NVM device 100 is assumed to be a flash memory device, but other types of NVM devices are contemplated by the inventive concept. For example, other embodiments of the inventive concept may include certain Read Only Memory (ROM), Electrically Programmable ROM (EPROM), Electrically Erasable and Programmable ROM (EEPROM), Random Access Memory (RAM), Phase-change RAM (PRAM), Magnetic RAM (MRAM), Ferro-Magnetic RAM (FRAM), resistance RAM (RRAM), etc.

In the description that follows, it is assumed that the NVM device 100 is configured to be iteratively programmed during a program operation. That is, “write data” (i.e., data designated to be programmed in the NVM device) is stored in the NVM device during execution of one or more programming iterations (or “programming loops”). Each programming loop typically includes a “program verification operation” that confirms an actual programming result for the programming iteration. The collective execution of one or more programming loop(s) with corresponding program verification operation(s) generally constitutes a program operation. During each programming loop a set of control signals (e.g., defined control voltages) is applied to a selected group of NVM cell(s) including at least one NVM cell in order to accomplish programming of the write data. The number of programming loops executed in a constituent program operation may be referred to as a “number of program” of “NOP”.

A program operation, or a programming loop within a program operation may be directed to a “page” of NVM cells. A page of NVM cells are typically understood as including a set (but necessarily all) of NVM cells coupled to a common word line.

Referring to FIG. 1, the NVM device 100 comprises; in relevant portion, a memory cell array 110, an address decoder 120, a read/write circuit 130, a data input/output (I/O) circuit 140, a pass/fail (P/F) check circuit 150, and control logic 160 including one or more high voltage (HV) generator(s).

The memory cell array 110 is connected to the address decoder 120 via a plurality of word lines (WL) and to the read/write circuit 130 via a plurality of bit lines (BL). The memory cell array 110 is formed by a plurality of NVM cells arranged in a matrix of the word lines and bit lines. For example, memory cells may be arranged in an arbitrarily defined “row direction” along the extension of the word lines, and an orthogonally related “column direction” along the extension of the lines. Individual NVM (e.g., flash memory) cells in the memory cell array 110 may be single-level memory cells (SLC) configured to store binary data, or multi-level memory cells (MLC) configured to store 2 or more bit data.

Hereafter, the NVM cells of the NVM device 100 according to certain embodiments of the inventive concept are assumed to be “programmed” by respective program operations, and “read” by respective read operations on a page-by-page basis. Each programmable/readable page of NVM cells may be further divided into or designated according to two or more “groups” of NVM cells. Different approaches to the division (or sub-designation) of NVM cells in a page of NVM cells may be collectively and singularly referred to as “logically dividing” the NVM cells of the page. Logical division into (e.g., first, second, etc. groups) may be accomplished using corresponding addresses for the NVM cells, for example. These addresses may be externally provided by (e.g.,) a memory controller, or internally generated within the NVM device 100.

The address decoder 120 operates in responsive to one or more control signals provided by the control logic 160. The address decoder 120 may be used to receive an externally-provided “input address” (ADDR), decode a row address from the input address, and select one or more word lines using the decoded row address. Control voltages may thus be selectively communicated to NVM cells of the NVM cell array 110 according to the selected word line(s) and unselected word lines during program, read, and/or erase operations. The control voltages communicated via the word lines may be provided by the control logic 160.

Additionally, the address decoder 120 may decode a column address from the input address and transfer it to the read/write circuit 130. As will be appreciated by those skilled in the art, embodiments of the inventive concept may include in addition to the address decoder 120 such elements as a row decoder, a column decoder, an address buffer, and so on. However, the provision and use of these elements is deemed conventional and will not be described in detail.

As noted above, the read/write circuit 130 is connected to the memory cell array 1210 via the bit lines. The read/write circuit 130 of FIG. 1 is also connected to the data I/O circuit 140 via data lines (DL), and the pass/fail check circuit 150. The read/write circuit 130 may be used to select one or more the bit lines in response to the decoded column address received from the address decoder 120. As with the word liens, control voltages generated during program, read, and/or erase operations may be communicated to NVM cells of the memory cell array 110 via selected and unselected bit lines. In FIG. 1, the read/write circuit 130 is assumed to receive write data (DATA) via the data I/O circuit 140 during a program operation and “read data” from the memory cell array 110 during a read operation.

Those skilled in the art will further recognize that the read/write circuit 130 may include such elements such as a page buffer (or page register), a column selecting circuit, a data buffer, and the like. But again, the provision and use of these elements is deemed conventional and will not be described in detail. However, in certain embodiments of the inventive concept, the read/write circuit 130 will include such conventionally understood elements as a sense amplifier, a write driver, a column selecting circuit, and a data buffer. Both the data I/O circuit 140 and read/write circuit 130 may be controlled by the control logic 160.

With this configuration, the data I/O circuit 140 may exchange data with one or more external device(s). The data I/O circuit 140 may be configured to transfer data provided from the external device to the read/write circuit 130 via the data lines. The data I/O circuit 140 may be configured to output data transferred from the read/write circuit 130 via the data lines DL to the external device.

The pass/fail check circuit 150 is connected to the read/write circuit 130. During a program operation, the pass/fail check circuit 150 may be configured to receive data read by the read/write circuit 130. The pass/fail check circuit 150 may be used to determine “program pass” verses “program fail” conditions based on the data provided from the read/write circuit 130.

For example, the pass/fail check circuit 150 may check whether all memory cells included in a first memory cell group have been properly programmed. In a case wherein all memory cells of the first memory cell group have been properly programmed, the pass/fail check circuit 150 will output a “pass signal” to the control logic 160, but in a case wherein fewer than all memory cells of the first memory cell group have been properly programmed, the pass/fail check circuit 150 may transfer a “fail signal” to the control logic 160.

In this manner, the pass/fail check circuit 150 may be used to check whether all of the memory cells in a plurality of memory cell groups have been properly programmed consistent with received write data.

As noted above, the control logic 160 generally controls the operation of the address decoder 120, read/write circuit 140, and pass/fail check circuit 150, as well as the overall operation of the NVM device 100. The control logic 160 may operate in response to a control signal (CTRL) received from an external device.

In certain embodiments of the inventive concept, the control logic 160 includes at least one HV generator that mat be used to generate one or more control voltages (e.g., a program voltage, a program verify voltage, a read voltage, a pass voltage, etc.). Certain control voltages, such as the program voltage and the program verify (or read) voltage, may be iteratively applied to selected word line(s) over a number of programming loops using a stepped (increasing or decreasing) control voltage format. Execution of successive programming loops during a program operation continues (up to a defined maximum number) until the pass signal is received from the pass/fail check circuit 120 indicating that the write data has been properly programmed. Hence, where incrementally adjusted (up or down), control voltage(s) are used during each successive programming loop, one or more defined increments (ΔV) may be used to define the control voltage(s) during a next programming loop.

Given the exemplary configuration of FIG. 1, the NVM device 100 may program a plurality of memory cell groups defined within a unit page using a program voltage and program verify voltage that varies in level according to the number of a “current programming loop” (i.e., a programming loop now being executed) within a sequence of programming loops necessary to properly program write data during a constituent program operation. Thus, each successive (and iteratively executed) programming loop will have a corresponding number of program (NOP), and the level(s) of certain control voltage(s) generated and applied during a respective programming loop will vary in accordance with its NOP.

For example, a program voltage and a program verify voltage may be applied to a first memory cell group of a first memory cell page during a first (i.e., an initial) programming loop of a current program operation presenting first write data to be stored in the NVM device 100. Hence, the NOP for the first programming loop is “1”, wherein a first level program voltage (Vpgm1) and a first level program verify voltage (Vvfy1) are associated with the NOP value of 1. Assuming that not all of the NVM cells of the first memory cell group are properly programmed by the first programming loop, the pass/fail check circuit 120 will return the fail signal, and the control logic 160 will “increment” the programming loop from the first programming loop to a second programming loop. The NOP for the second programming loop is “2”, wherein a second level program voltage (Vpgm2) and a second level program verify voltage (Vvfy2) are associated with the NOP value of 2. Here, it is assumed that the second level program voltage (Vpgm2) is incrementally (ΔV1) higher than the first level program voltage (Vpgm1), and that the second level program verify voltage (Vvfy2) is incrementally (ΔV2) higher than the first level program verify voltage (Vvfy2), wherein ΔV1 and ΔV2 may be the same or different.

It should be noted at this point that multiple memory cell groups will be commonly connected to a word line in a defined memory cell page. Thus, a program operation directed to a specified page in NVM may be functionally executed on a memory cell group by memory cell group basis. Further, since all of the NVM cells are commonly connected to the same word line, the respective threshold voltages for the NVM cells will vary with the iterative application of the control voltages over successive programming loops due to (e.g.,) process variations in the fabrication of the memory cells, F-poly coupling, etc.

Assuming a simple cases wherein first and second memory cell groups of a page are respectively and successively programmed during a program operation, a particular NOP (i.e., “N”) for a programming loop directed to the first group of cells will not necessarily be correlated with the same control voltage level(s) as the same NOP for an analogous programming loop directed to the second group of cell. For example, under the control of the control logic 160, a first programming loop (NOP=1) directed to the first memory cell group may generate and apply a (first group) first program voltage (Vpgm1A) and a (first group) first program verify voltage (Vvfy1A). Whereas, a first programming loop (NOP=1) directed to the second memory cell group may generate and apply a (second group) first program voltage (Vpgm1B) and a (second group) first program verify voltage (Vvfy1B), wherein Vpgm1A is different from Vpgm1B, and/or Vvfy1A is different from Vvfy1B.

The foregoing adaptation of control voltages on the basis of memory cell group may apply to only a first programming loop (and its corresponding start program voltage), or it may apply to the second and succeeding programming loops as well.

In view of the foregoing, the use of different start program voltages (at a minimum) and corresponding program verify voltages may markedly reduce the problems conventionally associated with F-poly coupling when like control voltages are sequentially applied to program first and second memory cell groups of a page. Under such conventional conditions, the threshold voltage distributions of the first memory cell group may vary due to the F-poly coupling, and this may result in a greater probability data error generation during subsequent read operations.

That is, using conventional programming techniques to program a second memory cell group in a page, undesirably shifts upward the threshold voltage distributions of some of the previously programmed NVM cells in a first memory cell group. However, by using a start program voltage and program verify voltage during the programming of the second memory cell group that are different from the start program voltage and program verify voltage used to program the first memory cell group this outcome may be avoided. In this manner, variation in the threshold voltage distributions of the first memory cell group may be compensated, as group by group voltage setups are relative. For example, a start program voltage and program verify voltage used for a first memory cell group may be lower than a start program voltage and program verify voltage used for a second memory cell group.

Also, under the control of the control logic 160, relative control voltage increment(s) may be variously defined for each memory cell group. Conventionally, threshold voltage distributions for the second memory cell group may be more widely established than threshold voltage distributions for the first memory cell group. However, in embodiments of the inventive concept threshold voltage distributions of the first memory cell group may be compensated.

During a read operation, the control logic 160 may supply a read voltage to a selected word line and a read pass voltage to unselected word line(s). The control logic 160 may then read a plurality of memory cell groups in a given page using different read voltage(s) and different read pass voltage(s) according to the NOP value with which the memory cells were programmed and in relation to the group sequence with which the memory cell were programmed.

Hence, different read voltages and different read pass voltages may be applied to a word line to read data programmed to a first memory cell group and to a second memory cell group in a page. The reason may be that threshold voltage distributions of the first memory cell group are different from threshold voltage distributions of the second memory cell group. In particular, the control logic 160 may supply a first read voltage to a selected word line and a first read pass voltage to an unselected word line to read data programmed at the first memory cell group. The control logic 160 may supply a second read voltage to a selected word line and a second read pass voltage to an unselected word line to read data programmed at the second memory cell group.

In certain embodiments of the inventive concept, the first read voltage may be higher than the second read voltage, or the first read voltage may be the same as the second read voltage. The first read pass voltage may be higher than the second read pass voltage, or the first read pass voltage may be the same as the second read pass voltage. Thus, it will be understood that the respective levels of read voltages and read pass voltages may be relatively determined.

In this manner, data read from a first memory cell group into the read/write circuit 130 may be transferred to the data I/O circuit 140 together with data read from the second memory cell group.

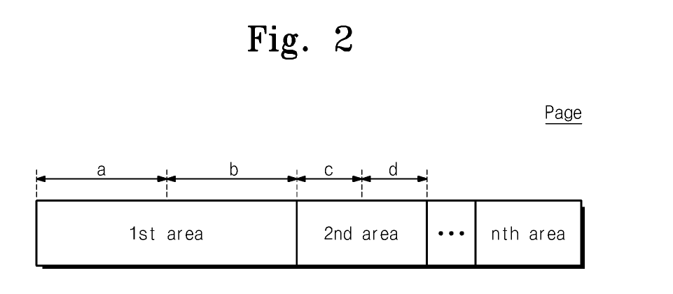

FIG. 2 is a conceptual diagram illustrating one possible unit page format for the memory cell array 110 of FIG. 1.

Referring to FIG. 2, the unit page (Page) includes a 1^{st} area, 2^{nd} area . . . to an Nth area. Each one of the first to Nth areas includes a plurality of MVN cells.

As described above, the NVM device 100 of FIG. 1 may be configured to “secure” (e.g., detect and store) the number of program (NOP) associated with the programming of a unit page. Thus, in a case where a single program operation successfully programs a single page, a NOP value of 1 might be secured. In contrast, in a case where four (4) areas of a page are independently programmed according to four (4) program operations, a NOP of 4 might be secured. Thus, a NOP may be given in relation to each programming loop of a program operation, and/or a NOP may be given in relation to a completed program operation without regard to constituent programming loops. This second approach arises from a view that the NVM cells of the page have been “programmed” only with completion of a program operation. In either event, when a program voltage is applied to a common word line, the threshold voltage distributions of previously programmed memory cells may be unintentionally shifted. This recognition drives, at least in part, the provision within embodiments of the inventive concept of different control voltage levels, as relatively determined by NOP conditions.

Returning to FIG. 2, it is now assumed that the 1^{st} and 2^{nd} areas have been programmed following application of two (2) program operations, resulting in a NOP value of 2. With this assumption, memory cells designated in the 1^{st} and 2^{nd} areas are logically divided into a first memory cell group and a second memory cell group based on their respective addresses. So, once the first memory cell group has been programmed, the second memory cell group is programmed. As a result, two program operations are executed.

In the illustrated example FIG. 2, the memory cells in each of the first and second memory cells groups need not be physically co-located. Rather, each memory cell groups is “logically” divided (e.g., by address) across one or more physical areas of a given page. For example, the first program operation in the working assumption is applied to the first memory cell group including NVM cells from sub-area “a” of the 1^{st} area and sub-area “c” of the 2^{nd} area among the NVM cells of the unit page. Similarly, the second program operation is applied to the second memory cell group including NVM cells from sub-areas “b” and “d”.

Thus, a defined memory cell group need only include NVM cells coupled to a common word line, and may include physically discontinuous arrangements of memory cells.

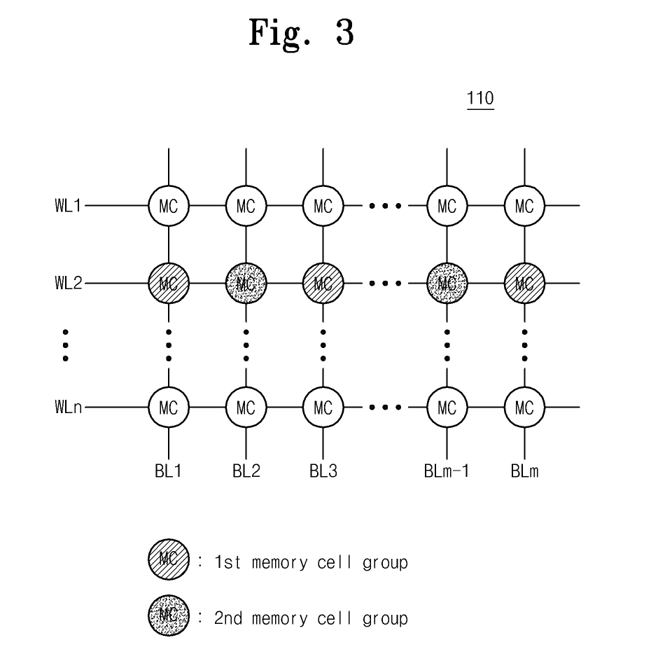

FIG. 3 is a conceptual diagram further illustrating one possible arrangement and group designation of memory cells from the unit page of FIG. 2 in the memory cell array 110 of FIG. 1.

Referring to FIG. 3, first to nth word lines WL1 to WLn and first to nth bit lines BL1 to BLm may be illustrated. Memory cells MC may be arranged at intersections of the word lines WL1 to WLn and the bit lines BL1 to BLm, respectively.

As described with reference to FIG. 1, a program operation may be performed by the page. In the case that 1-bit data is stored at a memory cell MC, memory cells MC connected to a word line (e.g., WL2) may form a page. In the case that 2-bit data is stored at a memory cell MC, memory cells MC connected to a word line (e.g., WL2) may form two pages.

For example, least significant bits of memory cells connected to the word line WL2 may form an LSB page and most significant bits of memory cells connected to the word line WL2 may form an MSB page. Likewise, when each memory cell MC stores i-bit data, memory cells MC connected to a word line may form i pages.

In FIG. 3, there is illustrated an example in which 1-bit data is stored at each of memory cells MC connected to a word line (e.g., WL2). Herein, in the case that NOP is 2, memory cells connected to a word line may be divided into a first memory cell group and a second memory cell group according to an externally applied address so as to be programmed or read independently. In FIG. 3, the first memory cell group may be formed of memory cells respectively corresponding to odd columns, and the second memory cell group may be formed of memory cells respectively corresponding to even columns. However, the inventive concept is not limited thereto.

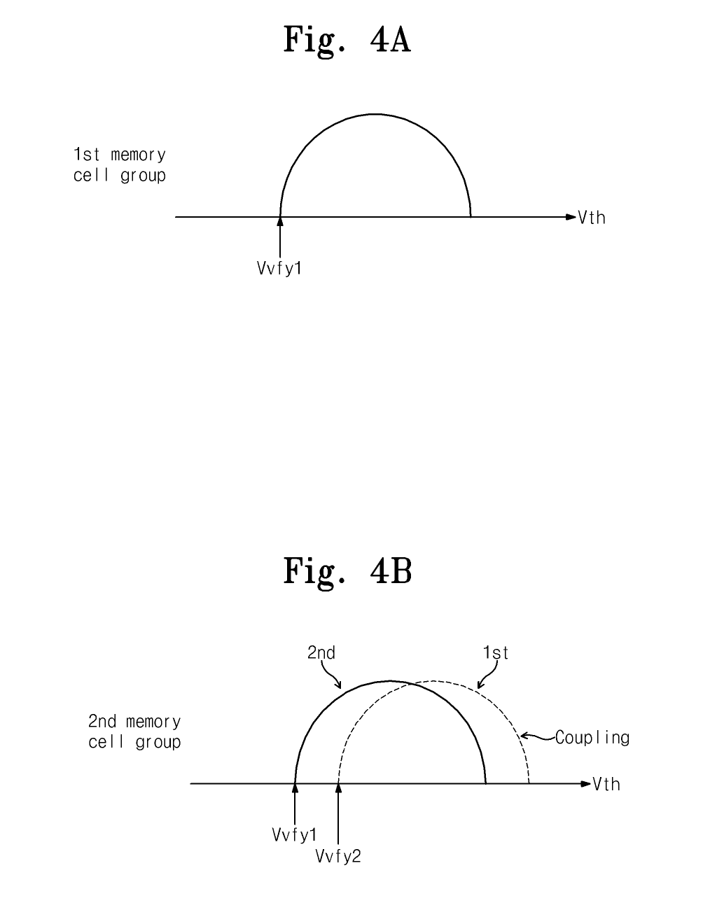

FIGS. 4A and 4B are diagrams illustrating a coupling phenomenon when selected memory cells in the memory cell array of FIG. 3 are programmed.

The threshold voltage distribution of FIG. 4A may be formed when memory cells, including in a first memory cell group, from among selected memory cells are programmed. Afterwards, during a program operation directed to memory cells of a second memory cell group, the threshold voltage distribution of memory cells in the first memory cell group may vary due to F-poly coupling, etc., as illustrated in FIG. 4B. For example, the threshold voltage distribution of memory cells in the first memory cell group may broaden beyond acceptable read tolerances.

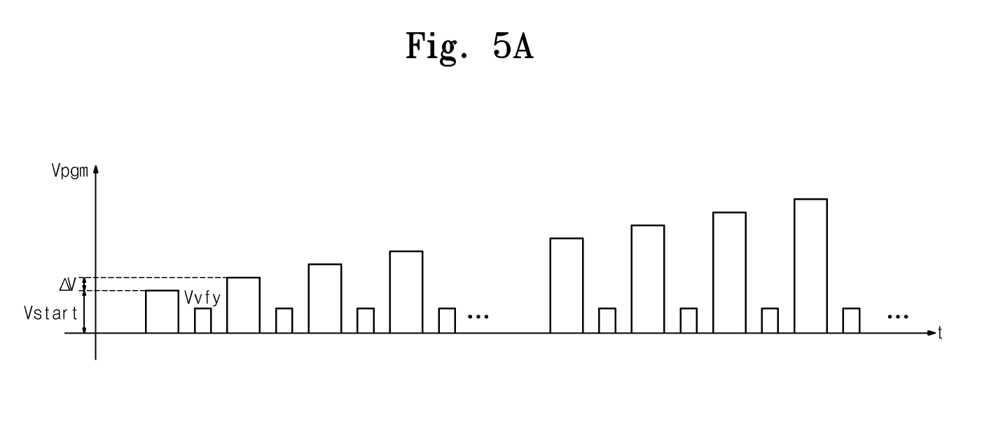

FIGS. 5A and 5B are voltage waveform diagrams illustrating a program operation for a nonvolatile memory device according to an embodiment of the inventive concept.

Referring to FIG. 5A, there is illustrated a first program operation for a nonvolatile memory device 100 having a NOP of 1. Since the NOP is 2, the nonvolatile memory device 100 will seek to a plurality of memory cell groups (e.g., first and second memory cell groups) in a unit page using a single program operation. In this case, the iterative programming loop is applied, the program voltage Vpgm is stepwise increased by an defined increment (ΔV) from a start program voltage (Vstart). As is conventionally understood, the program voltage Vpgm is applied to a selected word line, and then a verify voltage (Vvfy) is applied to the selected word line to check the programmed states of memory cells.

Referring to FIG. 5B, there is illustrated another program operation for the nonvolatile memory device 100 having a NOP of 2. Since the NOP is 2, the nonvolatile memory device 100 will seek to program the plurality of memory cell groups (e.g., first and second memory cell groups) in the unit page using two program operations.

Under these control conditions, a first program voltage Vpgm is stepwise increased by a defined first increment ΔV1 from a first start program voltage Vstart1 over a sequence of programming loops and applied to a selected word line to program the first memory cell group. A first program verify voltage Vvfy1 is applied to the selected word line to check the programmed states of memory cells in the first memory cell group.

Once the programming of the first memory cell group is completed, a second program voltage Vpgm is stepwise increased by a defined second increment ΔV2 from a second start program voltage Vstart2 over a sequence of programming loops and applied to the selected word line to program the second memory cell group. A second program verify voltage Vvfy2 is applied to the selected word line to check program states of memory cells in the second memory cell group.

In the illustrated embodiment of FIG. 5B, the first start program voltage Vstart1 is less than the second start program voltage Vstart2; the first increment ΔV1 is greater than the second increment ΔV2; and the first program verify voltage Vvfy1 is less than the second program verify voltage Vvfy2. However, these are just selected examples of possible relationships between these control signal sets.

Within the context of nonvolatile memory devices consistent with embodiments of the inventive concept, the program voltage and program verify voltage applied to different memory cell groups of page may vary with a given NOP.

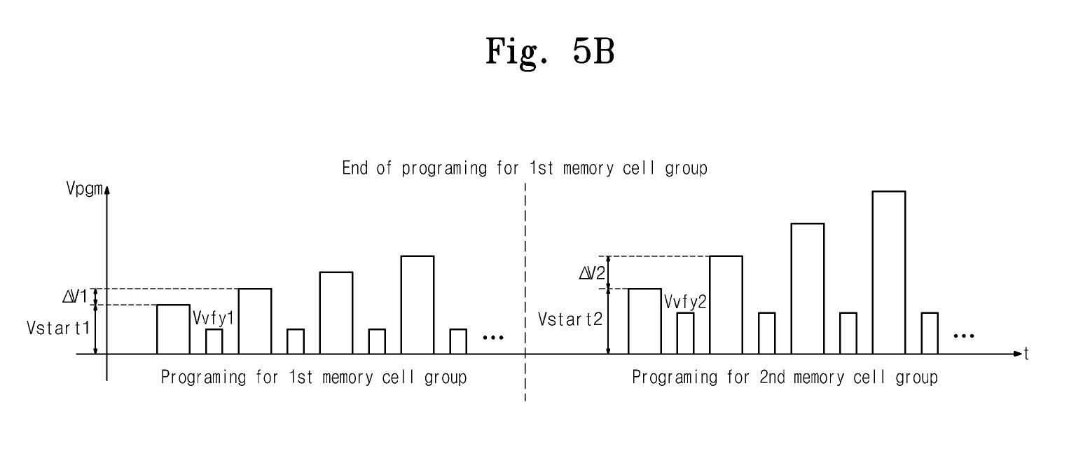

FIGS. 6A and 6B are waveform diagrams illustrating a program operation for a nonvolatile memory device according to an embodiment of the inventive concept.

Referring to FIGS. 6A and 6B, a nonvolatile memory device 100 according to an embodiment of the inventive concept may be configured to program memory cells in a unit page. (See, FIG. 2). These memory cells in the unit page mat be logically divided into a first memory cell group and a second memory cell group. For example, in the case that NOP is 2, the first memory cell group and the second memory cell group may be programmed, respectively.

Referring to FIG. 6A, control logic 160 of the nonvolatile memory device 100 may apply a first start program voltage Vstart1 to a selected word line to program the first memory cell group. Afterwards, a first verify voltage Vvfy1 may be applied to the selected word line to check a program state of the first memory cell group. That is, the selected word line may be supplied with a first program voltage Vpgm1 stepwise increasing by an increment ΔV1 according to iteration of program loops and a first verify voltage Vvfy1 for checking a program state of the first memory cell group.

The control logic 160 may perform program and verify operations on the first memory cell group until a pass signal is received from a pass/fail check circuit 150 or until the number of program loops reaches a predetermined loop number (e.g., a max loop number). If the pass signal is received or the number of program loops reaches a predetermined loop number, the control logic 160 may terminate the program and verify operations on the first memory cell group.

Referring to FIG. 6B, the control logic 160 of the nonvolatile memory device 100 may apply a second start program voltage Vstart2 to a selected word line to program the second memory cell group. Afterwards, a second verify voltage Vvfy2 may be applied to the selected word line to check a program state of the second memory cell group. That is, the selected word line may be supplied with a second program voltage Vpgm2 stepwise increasing by an increment ΔV2 according to iteration of program loops and a second verify voltage Vvfy2 for checking a program state of the second memory cell group.

A level of the second start program voltage Vstart2, a level of the second verify voltage Vvfy2, and the increment ΔV2 of the second program voltage Vpgm2 may be decided in view of the F-poly coupling forced to the first memory cell group at programming of the second memory cell group. For example, a level of the second start program voltage Vstart2 may be higher than a level of the first start program voltage Vstart1. A level of the second verify voltage Vvfy2 may be higher than a level of the first verify voltage Vvfy1. The increment ΔV2 of the second program voltage Vpgm2 may be larger than the increment ΔV1 of the first program voltage Vpgm1.

As described above, the F-poly coupling forced to the first memory cell group forced at programming of the second memory cell group may be reduced by setting a level of the second start program voltage Vstart2, a level of the second verify voltage Vvfy2, and an increment ΔV2 of the second program voltage Vpgm2 to be larger than a level of the first start program voltage Vstart1, a level of the first verify voltage Vvfy1, and an increment ΔV1 of the first program voltage Vpgm1. That is, it is possible to compensate a variation in a threshold voltage distribution of the first memory cell group which is widened or shifted into a high level. Thus, there may be reduced a bit error rate (BER) when data stored at the first and second memory cell groups is read.

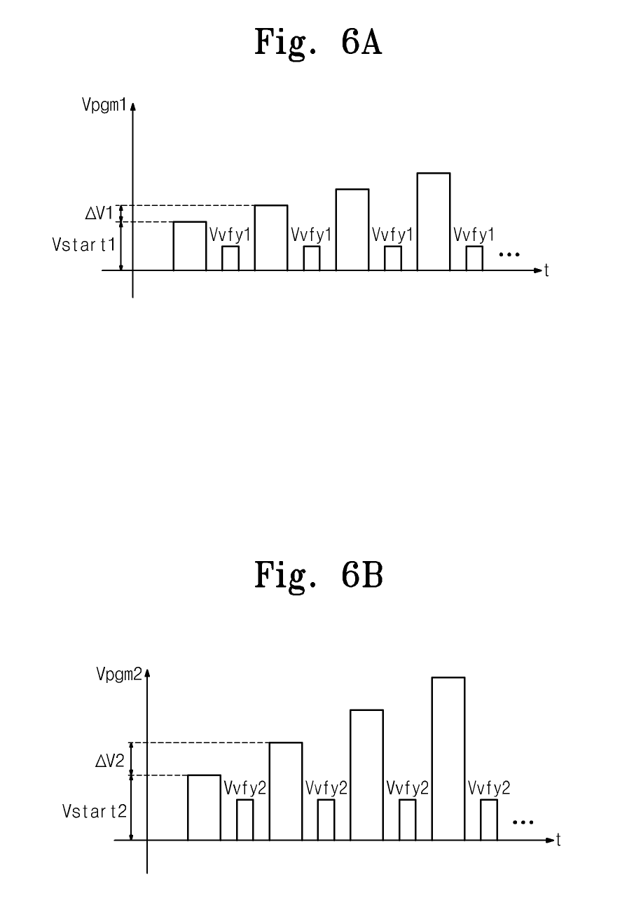

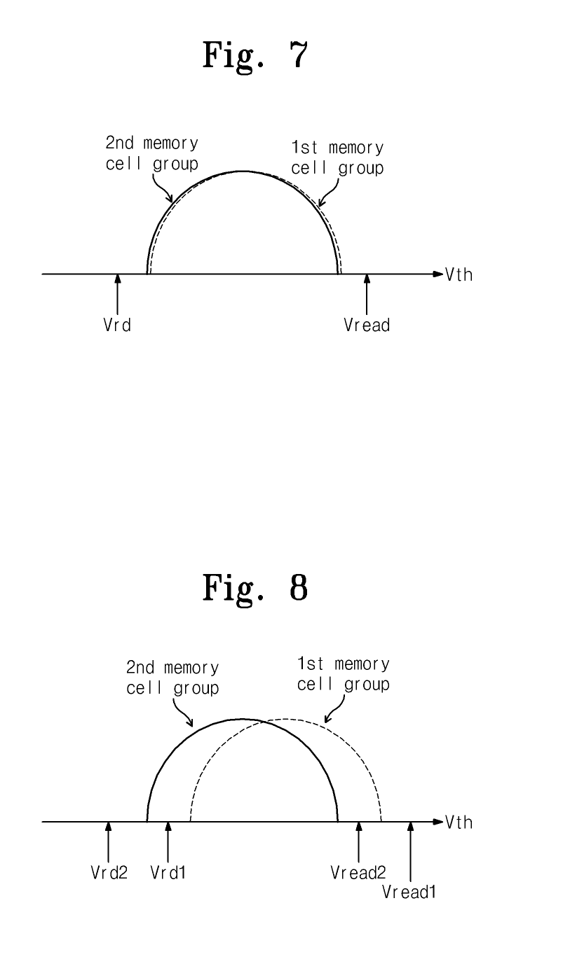

FIGS. 7 and 8 are diagrams illustrating a read operation for a nonvolatile memory device according to an embodiment of the inventive concept.

Referring to FIG. 7, threshold voltage distributions for first and second memory cell groups are illustrated. These threshold voltage distributions may be formed using the program operation described with reference to FIGS. 6A and 6B. In this case, control logic 160 may read data programmed at the first and second memory cell groups using the same read voltage Vrd and the same read pass voltage Vread. For example, data may be read by providing a selected word line with the read voltage Vrd lower than lower limits of the threshold voltage distributions of the first and second memory cell groups and an unselected word line with the read pass voltage Vread higher than upper limits of the threshold voltage distributions of the first and second memory cell groups.

Referring to FIG. 8, there may be illustrated threshold voltage distributions of the first and second memory cell groups which are formed according to a program operation described with reference to FIGS. 6A and 6B. Compared with FIG. 7, FIG. 8 may be understood as an example in which a compensation level on a variation in a threshold voltage distribution of the first memory cell group by the F-poly coupling is low. Also, FIG. 7 may be understood as an example in which the first and second memory cell groups are programmed using the same program voltage and the same verify voltage.

In this case, data programmed at the first memory cell group and data programmed at the second memory cell group may be read through independent read operations. The reason may be that a threshold voltage distribution of the first memory cell group is different from a threshold voltage distribution of the second memory cell group. For example, a first read voltage Vrd1 and a first read pass voltage Vread1 may be used to read data from the first memory cell group the threshold voltage distribution of which varies by the F-poly coupling. A second read voltage Vrd2 and a second read pass voltage Vread2 may be used to read data from the second memory cell group. A level of the first read voltage Vrd1 may be higher than a level of the second read voltage Vrd2, and a level of the first read pass voltage Vread1 may be higher than a level of the second read pass voltage Vread2.

An error generated at a read operation may be reduced by setting the first read voltage Vrd1, the first read pass voltage Vread1, the second read voltage Vrd2, and the second read pass voltage Vread2 as described above. That is, a bit error rate (BER) may be reduced.

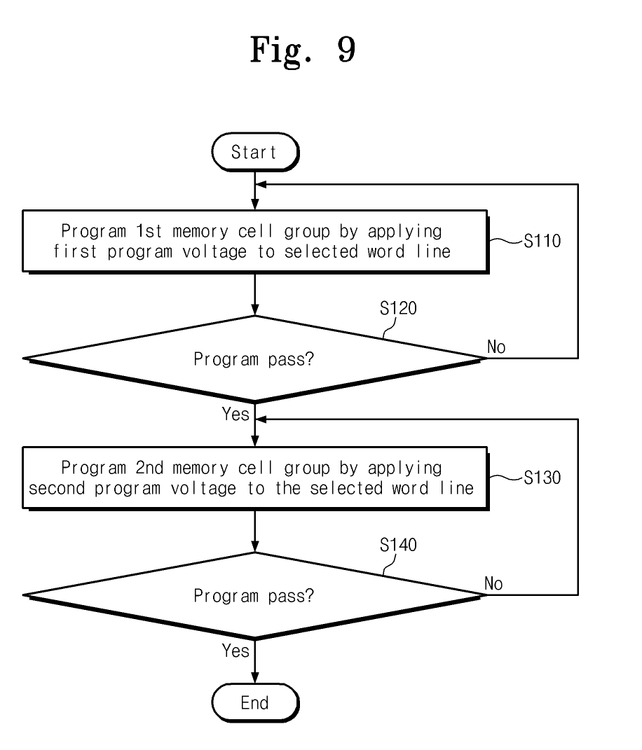

FIG. 9 is a flow chart summarizing a program method for a nonvolatile memory device according to an embodiment of the inventive concept.

Referring to FIG. 9, an operating method of a nonvolatile memory device according to an embodiment of the inventive concept may include programming a first memory cell group by applying a first program voltage to a selected word line (S110); checking a program state of the first memory cell group (S120); programming a second memory cell group by applying a second program voltage to the selected word line (S130); checking a program state of the second memory cell group (S140).

Herein, the first program voltage may be formed of a first start program voltage and an increment ΔV1 according to a program loop, and the second program voltage may be formed of a second start program voltage and an increment ΔV2 according to a program loop. A level of the second start program voltage may be higher than a level of the first start program voltage, and the increment ΔV2 may be larger than the increment ΔV1.

Herein, a program state of the first memory cell group may be checked by applying a first verify voltage to the selected word line. A program state of the second memory cell group may be checked by applying a first verify voltage to the selected word line. A level of the second verify voltage may be higher than a level of the first verify voltage.

As described above, the F-poly coupling forced to the first memory cell group forced at programming of the second memory cell group may be reduced by setting a level of the second start program voltage, a level of the second verify voltage, and an increment ΔV2 of the second program voltage to be larger than a level of the first start program voltage, a level of the first verify voltage, and an increment ΔV1 of the first program voltage. That is, it is possible to compensate a variation in a threshold voltage distribution of the first memory cell group which is widened or shifted into a high level. Thus, there may be reduced a bit error rate (BER) when data stored at the first and second memory cell groups is read.

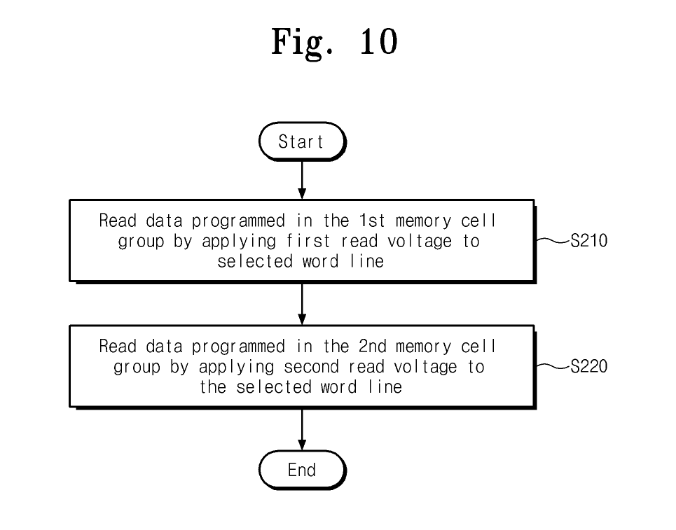

FIG. 10 is a flow chart summarizing read method for a nonvolatile memory device according to an embodiment of the inventive concept.

Referring to FIG. 10, a read method of a nonvolatile memory device according to an embodiment of the inventive concept may include reading data programmed at a first memory cell group by applying a first read voltage to a selected word line (S210); and reading data programmed at a second memory cell group by applying a second read voltage to a selected word line (S220).

The reading data programmed at a first memory cell group by applying a first read voltage to a selected word line may include applying a first read pass voltage to an unselected word line. The reading data programmed at a second memory cell group by applying a second read voltage to a selected word line may include applying a second read pass voltage to an unselected word line. A level of the first read voltage may be higher than a level of the second read voltage, and a level of the first read pass voltage may be higher than a level of the second read pass voltage.

As described above, an error generated at a read operation may be reduced by setting the first read voltage to be higher than the second read voltage and the first read pass voltage to be higher than the second read pass voltage. That is, a bit error rate (BER) may be reduced.

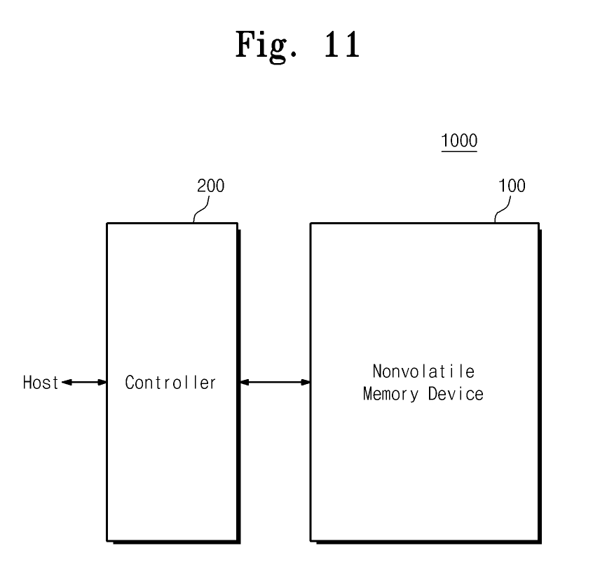

FIG. 11 is a block diagram schematically illustrating a memory system according to an embodiment of the inventive concept. Referring to FIG. 11, a memory system 1000 may include a nonvolatile memory 100 and a controller 200.

The controller 200 may be connected with a host and the nonvolatile memory device 100. In response to a request from the host, the controller 200 may be configured to access the nonvolatile memory device 100. For example, the controller 200 may be configured to control a read operation, a write operation, an erase operation, a read operation, and a background operation of the nonvolatile memory device 100.

The controller 200 may be configured to provide an interface between the nonvolatile memory device 100 and the host. The controller 200 may be configured to drive firmware for controlling the nonvolatile memory device 100. The controller 200 may be configured to provide the nonvolatile memory device 100 with a control signal CTRL, a command CMD, and an address ADDR. The controller 200 may be configured to exchange data with the nonvolatile memory device 100.

In example embodiments, the controller 200 may further include constituent elements such as a RAM, a processing unit, a host interface, and a memory interface. The RAM may be used as at least one of a working memory of the processing unit, a cache memory between the nonvolatile memory device 100 and the host, and a buffer memory between the nonvolatile memory device 100 and the host. The processing unit may control an overall operation of the controller 200.

The host interface may include the protocol for executing data exchange between the host and the controller 200. Exemplarily, the host interface may communicate with an external device (e.g., the host) via at least one of various protocols such as an USB (Universal Serial Bus) protocol, an MMC (multimedia card) protocol, a PCI (peripheral component interconnection) protocol, a PCI-E (PCI-express) protocol, an ATA (Advanced Technology Attachment) protocol, a Serial-ATA protocol, a Parallel-ATA protocol, a SCSI (small computer small interface) protocol, an ESDI (enhanced small disk interface) protocol, an IDE (Integrated Drive Electronics) protocol, and a Firewire.

The memory interface may interface with the nonvolatile memory device 100. The memory interface may include a NAND interface or a NOR interface.

The memory system 1000 may be configured to further include an error detecting and correcting block. The error detecting and correcting block may be configured to detect and correct an error of data read from the nonvolatile memory device 100 using ECC data (or, parity data).

In example embodiments, the error detecting and correcting block may be provided as a constituent element of the controller 200. In other example embodiments, the error detecting and correcting block may be provided as a constituent element of the nonvolatile memory device 100.

The controller 200 and the nonvolatile memory device 100 may be integrated to one semiconductor device. The controller 200 and the nonvolatile memory device 100 may be integrated to one semiconductor device to form a memory card. For example, the controller 200 and the nonvolatile memory device 100 may be integrated to one semiconductor device to form a memory card such as a PC (or, PCMCIA) card, a Compact Flash (CF) card, a SmartMedia (SM) card, a memory stick, a multimedia card (MMC, RS-MMC, MMCmicro), an SD card (SD, miniSD, SDHC), a Universal Flash Storage (UFS) device, or the like.

The controller 200 and the nonvolatile memory device 100 may be integrated to one semiconductor device to form a Solid State Drive (SSD). The SSD may include a storage device which is configured to store data using semiconductor memories. In case that the memory system 1000 is used as the SSD, an operating speed of a host connected with the memory system 1000 may be remarkably improved.

In example embodiments, the memory system 1000 may be used as computer, portable computer, Ultra Mobile PC (UMPC), workstation, net-book, PDA, web tablet, wireless phone, mobile phone, smart phone, e-book, PMP (portable multimedia player), digital camera, digital audio recorder/player, digital picture/video recorder/player, portable game machine, navigation system, black box, 3-dimensional television, a device capable of transmitting and receiving information at a wireless circumstance, one of various electronic devices constituting home network, one of various electronic devices constituting computer network, one of various electronic devices constituting telematics network, RFID, or one of various electronic devices constituting a computing system.

In example embodiments, a nonvolatile memory device 100 or a memory system 1000 may be packed by various types of packages such as PoP (Package on Package), Ball grid arrays (BGAs), Chip scale packages (CSPs), Plastic Leaded Chip Carrier (PLCC), Plastic Dual In-Line Package (PDI2P), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), and the like.

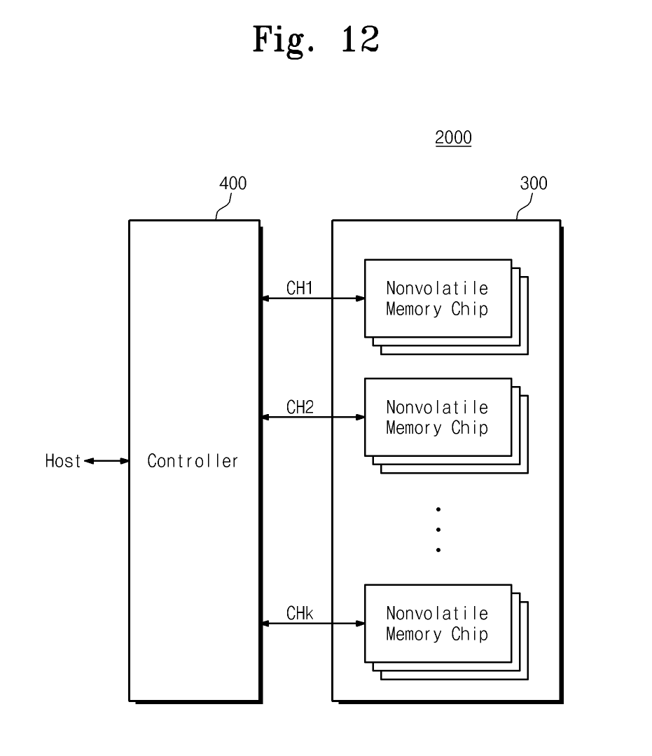

FIG. 12 is a block diagram illustrating an application of a memory system in FIG. 11. Referring to FIG. 12, a memory system 2000 may include a nonvolatile memory 300 and a controller 400. The nonvolatile memory 300 may include a plurality of nonvolatile memory chips, which form a plurality of groups. Nonvolatile memory chips in each group may be configured to communicate with the controller 400 via one common channel.

In FIG. 12, there is illustrated an example in which a plurality of nonvolatile memory chips may communicate with the controller 400 via a plurality of channels CH1 to CHk. Each nonvolatile memory chip may be configured the same or substantially the same as a nonvolatile memory device 100 described with reference to FIG. 1. The controller 400 may be configured the same or substantially the same as a controller 200 described with reference to FIG. 10.

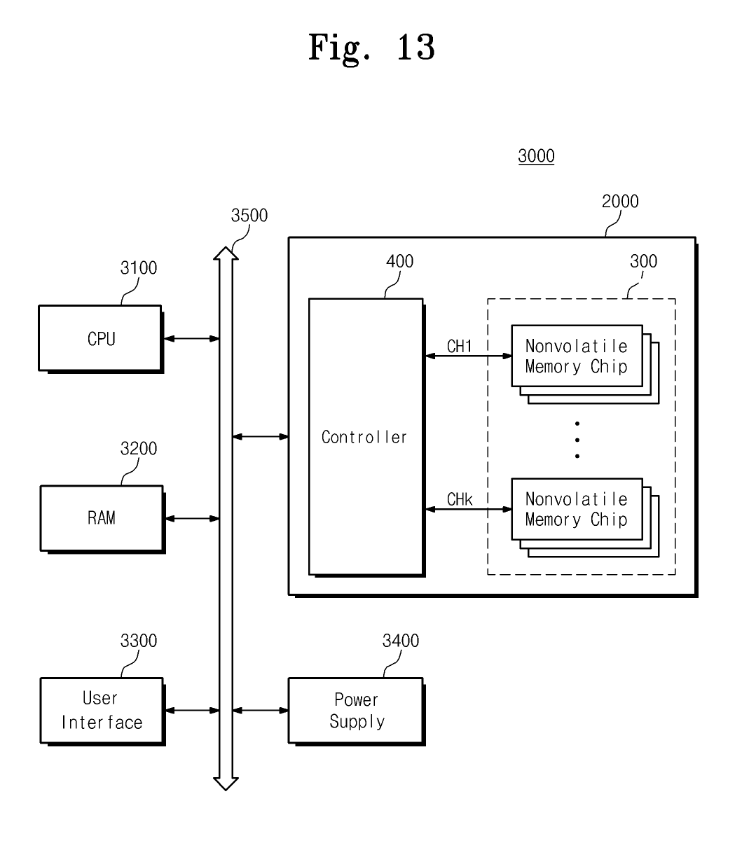

FIG. 13 is a block diagram schematically illustrating a computing system including a memory system in FIG. 12.

Referring to FIG. 13, a computing system 3000 may include a CPU 3100, a RAM 3200, a user interface 3300, a power supply 3400, and a memory system 2000.

The memory system 2000 may be connected with the elements 3100, 3200, 3300, and 3400 via a system bus 3500. Data provided through the user interface 3300 or processed by the CPU 3100 may be stored at the memory system 2000. The memory system 2000 may include a controller 400 and a nonvolatile memory device 300.

In FIG. 13, there is illustrated an example in which the nonvolatile memory device 300 is connected to the system bus 3500 via the controller 400. However, the nonvolatile memory device 300 can be connected directly to the system bus 3500. In this case, a function of the controller 400 described with reference to FIG. 12 may be performed by the CPU 3100.

In FIG. 13, the memory system 2000 may be a memory system described with reference to FIG. 12. However, the memory system 2000 can be replaced with a memory system 1000 described with reference to FIG. 11. In example embodiments, the computing system 3000 may be configured to include the memory systems 1000 and 2000.

While the inventive concept has been described with reference to exemplary embodiments, it will be apparent to those skilled in the art that various changes and modifications may be made without departing from the scope of the inventive concept. Therefore, it should be understood that the above embodiments are not limiting, but illustrative.

What is claimed is:

1. A method of programming data in a nonvolatile memory device having a memory cell array that arranges a first memory cell group and a second memory cell group in a page of memory cells commonly coupled to a selected word line, the method comprising:
executing a first program operation comprising; programming the first memory cell group by applying a first program voltage to the selected word line, wherein the first program voltage is stepwise adjusted by a first increment over successive programming loop iterations; and thereafter,
executing a second program operation; comprising; programming the second memory cell group by applying a second program voltage to the selected word line, wherein the second program voltage is stepwise adjusted by a second increment over successive programming loop iterations,
wherein the first program voltage is different from the second program voltage.

2. The method of claim 1, wherein the first program voltage is equal to a first start voltage during a first programming loop iteration of the first program operation, and the second program voltage is equal to a second start voltage different from the first start voltage during a first programming loop iteration of the second program operation.

3. The method of claim 2, wherein the first start voltage is less than the second start voltage.

4. The method of claim 2, wherein the first program voltage is stepwise adjusted upward by the first increment over successive programming loop iterations, and the second program voltage is stepwise adjusted upward by the second increment over successive programming loop iterations.

5. The method of claim 4, wherein the second increment is greater than the first increment.

6. The method of claim 1, wherein the first program operation further comprises; after applying the first program voltage to the selected word line during each successive programming loop iteration, applying a first program verify voltage to the selected word line having a first level; and
the second program operation further comprises; after applying the second program voltage to the selected word line during each successive programming loop iteration, applying a second program verify voltage to the selected word line having a second level,
wherein the second level is greater than the first level.

7. The method of claim 6, wherein the first program voltage is equal to a first start voltage during a first programming loop iteration of the first program operation, and the second program voltage is equal to a second start voltage different from the first start voltage during a first programming loop iteration of the second program operation.

8. The method of claim 7, wherein the first start voltage is less than the second start voltage.

9. The method of claim 7, wherein the first program voltage is stepwise adjusted upward by the first increment over successive programming loop iterations, and the second program voltage is stepwise adjusted upward by the second increment over successive programming loop iterations.

10. The method of claim 9, wherein the second increment is greater than the first increment.

11. A method of reading data in a nonvolatile memory device having a memory cell array that arranges a first memory cell group and a second memory cell group in a page of memory cells commonly coupled to a selected word line, the method comprising:
reading the first memory cell group by applying a first read voltage to the selected word line; and thereafter,
reading the second memory cell group by applying a second read voltage to the selected word line, wherein the first read voltage is different from the second read voltage.

12. The method of claim 11, wherein second read voltage is greater than the first read voltage.

13. The method of claim 11, wherein memory cells in at least one of the first and second memory cell groups are physically discontinuously along the selected word line.

14. The method of claim 13, wherein memory cells of the first memory cell group are odd memory cells as arranged along the selected word line, and memory cells of the second memory cell group are even memory cells as arranged along the selected word line.

15. A nonvolatile memory device, comprising:
a memory cell array arranging a first memory cell groups and a second memory cell group along a selected word line; and
control logic configured to provide the selected word line with a first program voltage during a first program operation directed to the first memory cell group, wherein the first program voltage is stepwise adjusted by a first increment over successive programming loop iterations of the first program operation, and thereafter, with a second program voltage during a second program operation directed to the second memory cell group, wherein the second program voltage is stepwise adjusted by a second increment over successive programming loop iterations, and the first program voltage is different from the second program voltage.

16. The nonvolatile memory device of claim 15, wherein the first program voltage is equal to a first start voltage during a first programming loop iteration of the first program operation, and the second program voltage is equal to a second start voltage different from the first start voltage during a first programming loop iteration of the second program operation.

17. The nonvolatile memory device of claim 16, wherein the first start voltage is less than the second start voltage.

18. The nonvolatile memory device claim 16, wherein the first program voltage is stepwise adjusted upward by the first increment over successive programming loop iterations, and the second program voltage is stepwise adjusted upward by the second increment over successive programming loop iterations.

19. The nonvolatile memory device claim 18, wherein the second increment is greater than the first increment.

20. The nonvolatile memory device of claim 15, wherein first memory cell groups and a second memory cell group respectively comprises flash memory cells.
